(19) United States
(12) Patent Application Publication
(10) Pub. No.: US 2026/0180869 A1
(43) Pub. Date: Jun. 25, 2026

(54) MACHINE-LEARNING BASED COMMUNICATION NETWORK MANAGEMENT WITH MISSING DATA VALUES

(71) Applicant: AT&T Intellectual Property I, L.P., Atlanta, GA (US)

(72) Inventors: Muhammad Umar Bin Farooq, Tulsa, OK (US); Farooq Bari, Kirkland, WA (US)

(21) Appl. No.: 18/988,875

(22) Filed: Dec. 19, 2024

(51) Int. Cl. H04L 41/16

(52) U.S. Cl. CPC H04L 41/16

(57) ABSTRACT

A processing system may detect one or more missing data values of a first network performance data feature type of a communication network for one or more time slots of a plurality of time slots and may generating one or more replacement data values for the one or more of the missing data values of the first network performance data feature type for the one or more time slots. The processing system may next apply an input vector comprising at least the one or more replacement data values to a first machine learning model to obtain an output of the first machine learning model in accordance with the input vector. The processing system may then perform at least one network management task in the communication network in response to the output.

The present disclosure relates generally to communication networks, and more particularly to methods, non-transitory computer-readable media, and apparatuses for performing at least one network management task in a communication network in response to an output of a first machine learning model in accordance with an input vector comprising one or more replacement data values for one or more missing data values of a first network performance data feature type.

### BACKGROUND

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. Ultimately, 5G may deliver superior high speed and performance.

### SUMMARY

In one example, the present disclosure discloses a method, computer-readable medium, and apparatus for performing at least one network management task in a communication network in response to an output of a first machine learning model in accordance with an input vector comprising one or more replacement data values for one or more missing data values of a first network performance data feature type. For example, a processing system including at least one processor may detect one or more missing data values of a first network performance data feature type of a communication network for one or more time slots of a plurality of time slots and may generate one or more replacement data values for the one or more of the missing data values of the first network performance data feature type for the one or more time slots. The processing system may next apply an input vector comprising at least the one or more replacement data values to a first machine learning model to obtain an output of the first machine learning model in accordance with the input vector. The processing system may then perform at least one network management task in the communication network in response to the output.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates an example process for missing data value handling, in accordance with the present disclosure;

FIG. 3 illustrates a flowchart of an example method for performing at least one network management task in a communication network in response to an output of a first machine learning model in accordance with an input vector comprising one or more replacement data values for one or more missing data values of a first network performance data feature type; and

FIG. 4 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for performing at least one network management task in a communication network in response to an output of a first machine learning model in accordance with an input vector comprising one or more replacement data values for one or more missing data values of a first network performance data feature type. In particular, examples of the present disclosure describe processes to handle missing data values within input data for one or more trained machine learning (ML) algorithms (MLAs), e.g., one or more machine learning model (MLMs) that is/are deployed for network management in a live communication network. Notably, network operations may rely on the output of the MLM(s), thus underscoring the particular significance of the output accuracy. To further illustrate, sixth generation (6G) cellular networks are anticipated to use artificial intelligence (AI)/ML-based algorithms from the ground up. Even in 5G-Advanced, ML-based solutions are increasingly being used in cellular network planning, operation, and optimization. Cellular networks may still predominantly utilize rule-based algorithms for network management. However, with the introduction of the network data analytics function (NWDAF) and the management data analytics function (MDAF) as 5G core network components, the use of AI/ML in 5G and beyond will only increase.

While solutions exist to address missing data values during the ML training phase, these do not account for missing data values for input features during the deployment and inference phase within live networks. In contrast, examples of the present disclosure anticipate that missing MLM input data will arise during the deployment and inference phase, and provide mechanisms designed to handle missing data values for one or more network performance data feature types during the deployment of a trained machine learning model in a live communication network. More specifically, in one example, the present disclosure may recognize and address five scenarios: (1) a MLM cannot execute with certain missing input data (e.g., the MLM will not converge to an output/solution and/or the MLM accuracy is diminished significantly such that it should not be used for any decision making in the communication network); (2) the MLM can execute with missing input data values; (3) there is a constraint on missing input data values for a consecutive T timeslots; (4) an active MLM has satisfactory performance (e.g., above a defined accuracy percentage, or the like), but a more optimal backup AI/ML model exists (e.g., with respect to missing input data values for a consecutive X timeslots); and (5) the frequency of data collection is different than the inference frequency (e.g., data collection has a higher frequency that the input data values that are used as MLM input(s)).

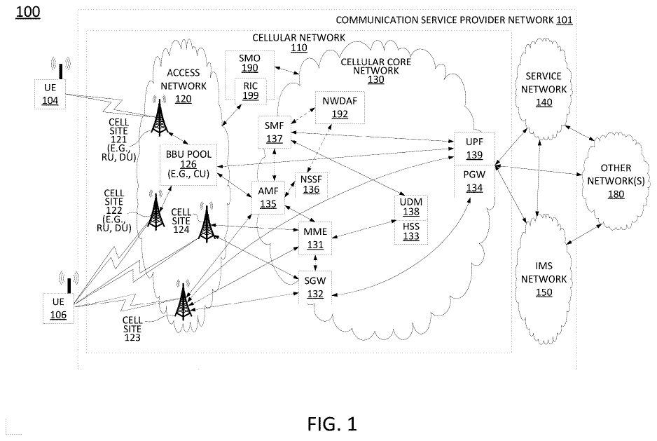

Thus, examples of the present disclosure provide several advantages. For instance, examples of the present disclosure may keep ML-aided live communication networks operational when some of the MLM input data values for one or more input data features is/are missing. In addition, examples of the present disclosure reduce potential network performance degradation in live cellular networks due to missing input data values. Examples of the present disclosure further Improve trust and confidence in MLMs and their benefits to communication networks operations. In addition, examples of the present disclosure avoid the waste of resources due to missing values as input(s) to one or more MLMs. These and other aspects of the present disclosure are discussed in greater detail below in connection with the examples of FIGS. 1-4.

To better understand the present disclosure, FIG. 1 illustrates an example network, or system 100 in which examples of the present disclosure may operate. In one example, the system 100 includes a communication service provider network 101. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In an Open RAN (O-RAN) architecture, these may alternatively or additionally be referred to as and/or may include radio units (RUs) (also referred to as O-RUs) and/or distributed units (DUs). In one example, the BBU pool 126 may be located at distances as far as 20-80 kilometers or more away from the antennas/remote radio heads of cell sites 121 and 122 that are serviced by the BBU pool 126. In an O-RAN architecture, these may alternatively or additionally be referred to as and/or may include centralized units (CUs). It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN and or O-RAN infrastructure may include distributed units (DUs), radio units (RUs)/RRHs and centralized units (CU), e.g., baseband units (BBUs), a heterogeneous network may include cell sites where RRH and BBU components (or CUs, DUs, and RUs) remain co-located at the cell site. For instance, cell site 123 may include RRH and BBU components (or an RU, DU, and CU). Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-124 may be deployed with antenna and radio infrastructures, including multiple input multiple output (MIMO) and millimeter wave antennas.

In one example, access network 120 may include both 4G/LTE and 5G radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126. In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, and a network data analytics function (NWDAF) 192.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

As noted above, cellular core network 130 further includes NWDAF 192, which may be tasked with monitoring various network functions, network slices, and access network components. In one example, NWDAF 192 may subscribe to data analytics (e.g., performance indicators/KPIs and/or configuration settings) from a variety of NFs, may store these analytics, and may provide such analytics to other NFs that may request such data. In accordance with the present disclosure, NWDAF 192 may track various performance indicators and/or configuration settings (broadly, RAN performance data) with respect to access network 120 and/or regarding particular components thereof (such as RUs, DUs, CU, etc., e.g., cell sites 121 and 122, BBU pool 125, cell sites 123 and 124, and so forth).

To illustrate, in one example, NWDAF may collect and store network function profiles. For instance, a network function profile (NFProfile) of a given NF may include a network function instance identifier (nfInstanceId), a network function type (nfType) defining the type of the NF instance, a network function status (nfStatus), a list of SE-NSSAIs supported/served by the NF (sNssais), a list of per-PLMN S-NSSAIs supported by the NF (perPlmnSnssaiList), a list of NSIs served by the NF (nsiList), a capacity of the NF (capacity), a load of the NF (load), a load timestamp indicating the last time when the load information of the NF was updated (loadTimeStamp), IPv4 and IPv6 address(es) of the NF, and so forth. Similarly, NWDAF 192 may alternatively or additionally collect and store downlink signal information and uplink signal information, e.g., for cell sites, sectors, or the like. In one example, NWDAF 192 may also collect and store other relevant data as additional fields of such records, or in connection with such records. For example, records of RAN performance data may include information identifying the cell, sector, antenna, and/or antenna array, the equipment type (e.g., antenna and/or feed network manufacturer, make, model, etc.), a location (e.g., latitude, longitude, and/or elevation), a type of deployment, e.g., rooftop, standalone, etc., and so forth. NWDAF 192 may also collect and store external/third-party data, such as weather data (e.g., temperature, humidity, precipitation indication, precipitation volume, etc.). In general, NWDAF 192 may collect and store various types of network performance data and/or external/3^{rd} party data for different artificial intelligence (AI) and/or machine learning models (MLMs) that may be trained and deployed (e.g., for operation by NWDAF 192). In this regard, NWDAF 192 may also train and store one or more AI models and/or machine learning models (MLM) for various network management tasks, e.g., network management inference tasks such as prediction/forecasting, classification, detection, or the like. For instance, a first MLM may be for network impairment detection (e.g., for past or present occurrences), a second MLM may be for network impairment forecasting (e.g., for future time periods), a third MLM may be for network intrusion detection, a fourth MLM may be for demand spike forecasting, and so forth.

It should be noted that as referred to herein, a machine learning model (MLM) (or machine learning-based model) may comprise a machine learning algorithm (MLA) that has been “trained” or configured in accordance with input training data to perform a particular service. For instance, a MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

In one example, NWDAF 192 may train and deploy one or more MLMs for one or more network management inference tasks. In one example, NWDAF 192 may train and deploy multiple MLMs for a same network management inference task, but for different geographic regions (e.g., states, groups of states, etc.), for different tracking areas, for different equipment types, for different deployment types (e.g., rooftop versus non-rooftop/standalone), and so on. Alternatively, or in addition, these factors may comprise additional inputs/predictors for a trained MLM, where the MLM may learn and generate outputs based upon the relevance of these different inputs/predictors. To further illustrate, in one example, NWDAF 192 may apply an input vector comprising RAN performance data associated with cell site 121 to a network impairment detection/forecasting model to generate an output indicating whether cell site 121 is experiencing and/or is predicted to exhibit a network impairment at a future time period. Various other types of input vectors with sets of one or more different data value types may be used for various other MLMs that are trained/configured for various additional network management inference tasks, such as those noted above and others.

In one example, NWDAF 192 may further store the results/outputs of the one or more MLMs in operation thereon in response to various input data samples/vectors. In one example, NWDAF 192 may provide individual or aggregate reports to one or more other NFs, e.g., on a subscription basis and/or on-demand. For instance, service and management orchestrator (SMO) 190 and/or RAN intelligent controller (RAN-IC or RIC) 199 thereof may obtain alerts, reports, or the like from NWDAF 192, and may use such information to automatically configure/reconfigure one or more aspects of cell site 121 and/or access network 120. Likewise, in one example NWDAF 192 may provide alerts, reports, or the like to one or more endpoint devices of network personnel, e.g., for manual investigation, troubleshooting, and/or remediation, for network planning, and so forth.

In accordance with the present disclosure a machine learning model may be trained/configured to work with input data vectors comprising data values of one or more data feature types for one or more time periods, e.g., to generate an output comprising a prediction, a classification, etc. However, examples of the present disclosure recognize that it may be possible that there are missing data values for one or more of the network performance data features types for one or more time periods. For example, this can arise due to a variety of causes, such as a network element, or network function being turned off, resetting, or the like, failing to collect one or more data values for one or more data feature types in one or more time periods, e.g., due to sensor errors, misconfiguration, etc., failing to properly store the data values before reporting to NWDAF 192, etc. or by manual error, such as network personnel deleting one or more data values stored in NWDAF 192, or even entire columns or rows/records of data, and so forth. Thus, while NWDAF 192 may be configured to apply an input vector to an MLM implemented by the NWDAF 192, the input vector may be missing one or more expected values.

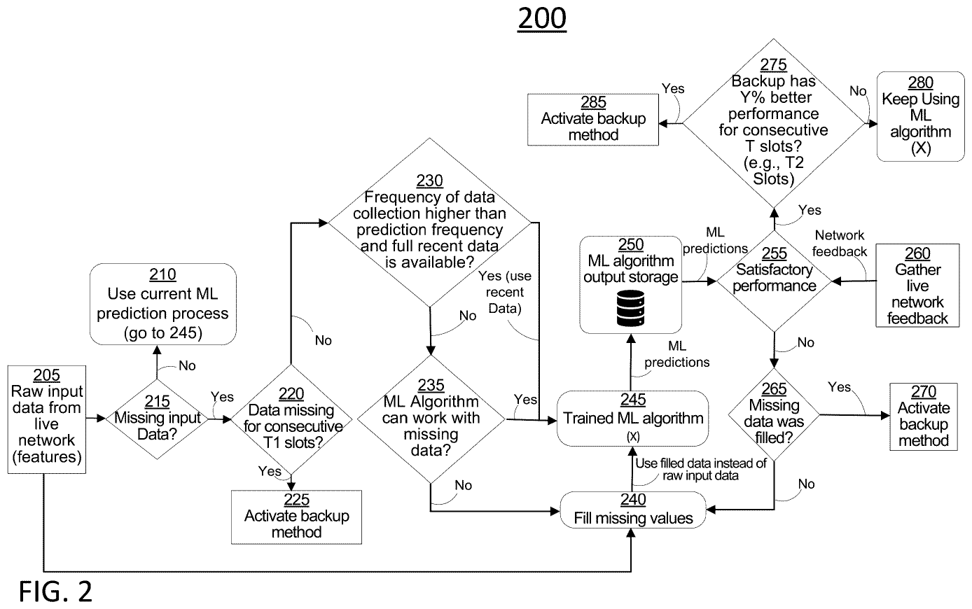

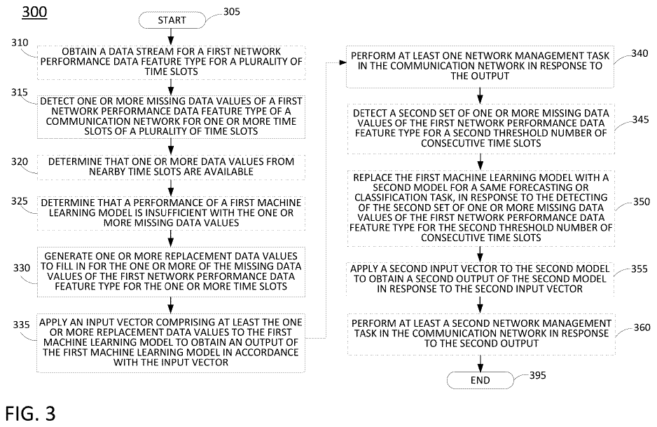

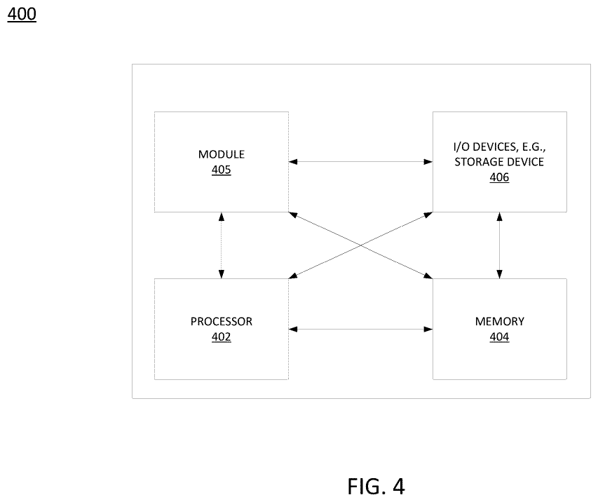

In this regard, in one example, NWDAF 192 may be configured to implement a missing data value handling process, such as illustrated and described in connection with the example process 200 of FIG. 2 and/or the example method 300 of FIG. 3. For instance, aspects of the present disclosure for performing at least one network management task in a communication network in response to an output of a first machine learning model in accordance with an input vector comprising one or more replacement data values for one or more missing data values of a first network performance data feature type, e.g., as described in greater detail below in connection with the example method 300 of FIG. 3, may be performed by NWDAF 192. In this regard, in one example, NWDAF 192 may comprise all or a portion of a computing device or system, such as computing system 400, and/or processing system 402 as described in connection with FIG. 4 below, and may be configured to perform various operations in connection with examples of the present disclosure for performing at least one network management task in a communication network in response to an output of a first machine learning model in accordance with an input vector comprising one or more replacement data values for one or more missing data values of a first network performance data feature type.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 4 and discussed below) or multiple computing devices collectively configured to perform various steps, functions, and/or operations in accordance with the present disclosure.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

FIG. 1 also illustrates various mobile endpoint devices, e.g., user equipment (UE) 104 and 106. UE 104 and UE 106 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, each of the UE 104 and UE 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of the UE 104 and UE 106 may also include a gyroscope and compass to determine orientation(s), a global positioning system (GPS) receiver for determining a location, and so forth. As illustrated in FIG. 1, UE 104 may access wireless services via the cell site 121, while UE 106 may access wireless services via any of cell sites 122-124 located in the access network 120.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, NWDAF 192, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular network 110 may also include a service and management orchestrator (SMO) 190. For instance, in one example, SMO 190 may comprise a self-optimizing network (SON) orchestrator and/or software defined network (SDN) controller. To illustrate, SMO 190 may function as a self-optimizing network (SON) orchestrator that is responsible for activating and deactivating, allocating and deallocating, and otherwise managing a variety of network components. For instance, SMO 190 may activate and deactivate antennas/remote radio heads of cell sites 121 and 122, respectively, may allocate and deactivate baseband units in BBU pool 126, and may perform other operations for activating antennas based upon a location and a movement of an endpoint device or a group of endpoint devices, in accordance with the present disclosure.

In one example, SMO 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SMO 190 may be connected directly or indirectly to any one or more network elements of cellular core network 130, access network 120, and of the system 100 in general. Due to the relatively large number of connections available between SMO 190 and other network elements, none of the actual links to the SON/SDN controller 190 are shown in FIG. 1. Similarly, intermediate devices and links between MME 131, SGW 132, cell sites 121-124, PGW 134, AMF 135, NSSF 136, SMF 137, UDM 138, NWDAF 192, and/or UPF 139, and other components of system 100 are also omitted for clarity, such as additional routers, switches, gateways, and the like.

In one example, SMO 190 may include a RAN intelligent controller (RAN-IC or RIC) 199. For instance, in an O-RAN architecture, the RIC 199 may be deployed for managing and controlling various RAN components/functions, e.g., CUs, DUs, and RUs. For instance, RIC 199 may comprise a platform that hosts various RAN applications (e.g., xApps/rApps) that may be used to configure and reconfigure various components of access network 120. For instance, rApps may refer to “non-real-time apps” and xApps may refer to “near-real-time apps.” In accordance with the present disclosure, both xApps and rApps may be referred to as “RAN applications,” “RAN apps,” “applications,” or simply “apps.” In one example, aspects of RIC 199 may represent functionality of an SON orchestrator, or vice versa. In one example, RIC 199 and/or SMO 190 may request and/or subscribe to various information that may be obtained and stored by NWDAF 192. Such information may include time-stamped RAN performance indicators (e.g., KPIs for various time blocks/intervals), RAN environment state information (e.g., RAN parameters and/or settings associated with the time blocks/intervals for which performance indicators may be measured/collected), or the like. Alternatively, or in addition RIC 199 and/or SMO 190 may obtain various information from RAN components or other network elements directly (e.g., without NWDAF 192 as an intermediary).

In one particular example, SMO 190 and/or RIC 199 may train and/or deploy one or more MLMs for one or more network management inference tasks (e.g., which may be RAN-specific). For instance, SMO 190 and/or RIC 199 may train and/or deploy multiple MLMs for a same network management task, but for different geographic regions (e.g., states, groups of states, etc.), for different tracking areas, for different equipment types, for different deployment types (e.g., rooftop versus non-rooftop/standalone), and so on. In one example, the one or more MLMs may be deployed as xApps or rApps. Similar to the above, SMO 190 and/or RIC 199 may be configured to apply an input vector to a MLM implemented by the SMO 190 and/or RIC 199. In addition, SMO 190 and/or RIC 199 may then configure/reconfigure one or more aspects of access network 120, cellular core network 130, and/or one or more network slices deployed over the infrastructure of access network 120 and cellular core network 130 in response to outputs of the one or more MLMs. For instance, SMO 190 and/or RIC 199 may transmit instructions to a base station to reduce transmit power in one or more downlink frequencies, carriers, sub-carriers, frequency channels, PRBs, or the like, to omit or reduce utilization of one or more uplink frequencies carriers, sub-carriers, frequency channels, PRBs, or the like, and so forth. Alternatively, or in addition, SMO 190 and/or RIC 199 may transmit instructions to a base station to perform beam steering, e.g., to direct a null in a direction of external PIM, to alert an active probing system to collect more samples with respect to a particular cell, sector, etc., to apply one or more heuristics/algorithms that may be configured to perform active diagnostics at a cell site for further analysis and corresponding mitigation measures, and so forth.

However, as in the preceding example(s), the input vector may be missing expected values. In this regard, in one example, SMO 190 and/or RIC 199 may likewise be configured to implement a missing data value handling process, such as illustrated and described in connection with the example process 200 of FIG. 2 and/or the example method 300 of FIG. 3. For instance, aspects of the present disclosure for performing at least one network management task in a communication network in response to an output of a first machine learning model in accordance with an input vector comprising one or more replacement data values for one or more missing data values of a first network performance data feature type, e.g., as described in greater detail below in connection with the example method 300 of FIG. 3, may be performed by RIC 199 and/or SMO 190. In this regard, in one example, RIC 199 and/or SMO 190 may comprise all or a portion of a computing device or system, such as computing system 400, and/or processing system 402 as described in connection with FIG. 4 below, and may be configured to perform various operations in connection with examples of the present disclosure for performing at least one network management task in a communication network in response to an output of a first machine learning model in accordance with an input vector comprising one or more replacement data values for one or more missing data values of a first network performance data feature type. Accordingly, it should be further noted that in some examples, aspects described herein with respect to NWDAF 192 may alternatively or additionally be performed by SMO 190 and/or RIC 199, and vice versa.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In this regard, it should be noted that although the foregoing is primarily described in connection with NWDAF 192, SMO 190, and RIC 199, in other, further, and different examples, aspects of the present disclosure may be deployed and may be in operation on other network elements/systems that may utilize machine learning, such as NSSF 136, UDM 138, UPF 139, and so on. Similarly, although aspects of the present disclosure are described herein primarily in connection with cellular networks, in other, further, and different examples, the missing data value handling process(es) of the present disclosure may include applications to non-cellular wireless networks, e.g., Institute of Electrical and Electronics Engineers (IEEE) 802.11/Wi-Fi networks, satellite communication networks, wired communication networks (e.g., fiber optic networks, cable access networks, etc.), enterprise or other local area networks (LANs), and so forth.

In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. It should be noted that the example described above involves a 4G-to-5G PDN connection transfer (and 5G-to-4G reversion) that includes UE 106 transferring from cell site 124 to cell site 122 (and vice versa). However, in another example, UE 106 may establish a 4G session to a PDN via 4G/LTE components of cell site 123, and may be transferred to a 5G connection via 5G components of the same cell site 123 in response to one or more trigger conditions as described above.

In addition, network elements or functions that are illustrating as being deployed in one portion of the communication service provider network 101 may alternatively or additionally be deployed in another portion of the communication service provider network 101. For example, SMO 190 may be deployed in cellular core network 130, within access network 120, or may comprise a distributed computing platform having hardware components within cellular core network 130 and access network 120. Thus, these and other modifications are all contemplated within the scope of the present disclosure.

FIG. 2 illustrates an example process 200 for missing data value handling in accordance with the present disclosure. In one example, the process 200 may be performed by a processing system including at least one processor deployed in a communication network, such as a NWDAF, a RIC, or other network elements, systems, or components. In particular, the process 200 may begin at 205 where raw input data is collected from a live network. The input data (e.g., for ML-based inference at a subsequent stage) may be of one or more data feature types, or “features,” and may be for one or more time periods (and/or may comprise a stream, or time series of data). At 215, the processing system may determine whether there are any missing data values for one or more data feature types (and for one or more time slots). If not, then the processing system may utilize the input data features as at least a portion of an input vector, or vectors, to a currently active ML prediction process (e.g., an active MLM). However, if there are missing data values, the process 200 may proceed to 220. At 220, the processing system may determine whether data values of a data feature type are missing for more than a consecutive T1 time slots (e.g., T1 may be an integer value of: 4, 5, 6, 7, etc.). If yes, the process 200 may proceed to 225 where a backup method may be activated (e.g., to use a backup method instead of the current primary/active MLM). For instance, the backup method may comprise another MLM, an AI model/process, a formula or rule-based model, or the like. In one example, T1 may comprise a pre-determined number of time slots, and may be based upon past observations of performance of the active/primary MLM for a given network management inference task. For example, empirical observations may indicate that the MLM accuracy drops below a threshold desired accuracy level when more than T1 consecutive time slots of data values of a given data feature type are missing. In any case, if the input data values are missing for T1 or less consecutive time slots, the process 200 may proceed to 230.

At 230, the processing system may determine whether a frequency of data collection is greater than a prediction frequency (e.g., an inference, classification, forecast, and/or prediction frequency) and whether full recent data is available. For instance, while there may be one or more data values missing, the MLM may utilize samples of the data from one or more nearby time slots, e.g., from one or more adjacent time slot(s) to the time slots of the one or more missing data values. In the case that such data values are available, the recent data may be used instead, and fed as part of an input vector to the trained ML algorithm (MLA) (X) at 245. However, if recent alternative data values are not available, the process 200 may proceed to 235 where it may be determined whether the MLA (X) can work with the missing data values. For instance, the processing system may check the nature of the MLA (X) and whether or not it can proceed without providing data values for certain features. One example is naïve Bayes algorithm that can still proceed if values of one or more features are missing. If yes (e.g., if MLA (X) can operate with missing data values), the process 200 may proceed to step 245 where the available data values are input to the current deployed MLA (X) as-is (i.e., with some data values missing). On the other hand, if it is determined that the current deployed MLA (X) cannot function with one or more missing data values, the process 200 may instead proceed to 240.

At 240, the processing system may fill in the missing data values (e.g., all of the missing data values, or at least a portion thereof such that the anticipated performance may exceed the threshold). For instance, 240 may include generating one or more synthetic data values to replace/fill-in for the missing data values. To further illustrate, in various examples, the synthetic data may be generated in one or more ways using other available data values for one or more data feature types, such as using statistical processes/methods (e.g., averaging, interpolation, regression, etc.) and/or via generative machine learning approaches (e.g., using a generative adversarial network (GAN), a variational autoencoder (VAE), a generative pre-trained transformer (GPT) model, or the like). For instance, in one example, the processing system may implement one or more supplemental models that are configured for the processing system to generate the synthetic data. In one example, different synthetic data generation techniques may be used with respect to missing data values for different data feature types (e.g., one method may work better for a first data feature type, while another method may provide better synthetic data for a different data feature type) and/or for different types of MLAs/MLMs (e.g., one method may work better for a first MLA/MLM type, while another method may provide better synthetic data for a different MLA/MLM type).

Following 240, the process 200 may proceed to 245 where a set of data values (including the synthetic data values replacing the one or more missing data values) are input to the MLA (X) as one or more input vectors. For instance, as noted above, the processing system may implement MLA (X) (and in one example, one or more other MLAs/MLMs or other inference models for one or more network management tasks). As such, 245 may include generating/obtaining one or more outputs of MLA (X) (e.g., ML predictions (which may broadly refer to predictions, inferences, forecasts, classifications, etc.)). In any case, the output(s) may be stored at 250, e.g., in a data storage system that is a component/part of the processing system, or that is external and accessible to the processing system. In one example, the output(s) may further be used to implement one or more network management tasks, such as reconfiguring one or more aspects of the communication network, or generating alerts, reports, or the like, which may be transmitted to network personnel endpoint devices and/or to one or more other automated systems of the communication network.

In one example, the output(s) stored at 250 may be used for subsequent and ongoing evaluation of the performance of MLA (X). For instance, as illustrated in FIG. 2, the process 200 may further include gathering live network feedback at 260. For example, 260 may include gathering network performance data and comparing the network performance data to the output(s) of MLA (X), e.g., the predictions/forecasts, classifications or the like. To illustrate, for a binary output/classification, 255 may include determining whether the classification was correct (i.e., was the performance satisfactory). For instance, the output(s) may indicate a prediction that a cell sector had suffered an outage in one or more past time periods or would suffer an outage at one or more future time periods. The live network feedback gathered at 260 may indicate whether this was in fact true. Taken over many samples, an overall accuracy may be determined, e.g., through averaging, time weighted averaging, etc. Likewise, for non-categorical forecasts/predictions, an accuracy may comprise a measure of how far off a predicted/forecast value is from the actual observed value at a subject time interval. In addition, taken over many samples, an overall accuracy may be determined. 255 may further include determining whether the performance (e.g., accuracy, F1 score, root mean square error, R2 score, and/or a combination of these or similar metrics) is acceptable. For instance, this may comprise determining that the performance metric(s) exceed one or more thresholds, which may be user-defined (e.g., selected by network personnel) and/or which may be set in response to an automated objective criterion, such as a performance threshold of another system or process that relies upon the output(s) of MLA (X).

If it is determined that the performance of MLA (X) is not acceptable, the process 200 may proceed to 265 where the processing system may determine whether missing data values were filled-in. If no, the process 200 may return to 240 where the missing values (e.g., all or some of the missing data value(s)) may be generated and filled in. In such case, the process 200 may repeat 245 with new input vector(s) with additional synthetic data. On the other hand, if at 265 it is determined that missing data values were already filled in and the performance of MLA (X) is still unacceptable, the process 200 may proceed to 270 where the processing system may activate a backup method such as mentioned above.

It should be noted that as further illustrated in FIG. 2, in one example, even if MLA (X) is determined to have acceptable performance at 255, the process 200 may nevertheless proceed to 275. At 275, the processing system may determine whether a backup method/model may have superior performance, e.g., for missing data of a consecutive T2 time slots. For instance, in one example, the processing system may implement one or more backup methods/models to operate in parallel to the primary/active MLM (X) for the same network management inference task. In addition, the performance of the backup method(s)/model(s) may be similarly evaluated, e.g., using the live network feedback collected at 260. In one example, where the performance of a backup method/model is superior, the backup method/model may be activated at 285 (or the processing system may configure itself to activate the backup method/model when new data is encountered that is missing data values from a consecutive T2 time slots (or more) with respect to a given data value type). In other words, even though MLA (X) is found to have acceptable performance, a different method/model may be activated because still higher performance (e.g., higher accuracy) may be obtained. On the other hand, if MLA (X) is determined to still have superior performance, the process 200 may proceed to 280 where it is determined to keep using MLA (X) as the primary model for a network management inference task in the communication network.

It should be noted that the process 200 is just one example of missing data value handling in accordance with the present disclosure, and that other, further, and different examples may have a different process flow, may include more or less stages, may omit stages, may combine stages, may perform stages in a different order, and so forth. As just one example, 230, 235, and 240 may be collapsed into a single stage, where the use of nearby data values may be one of several available techniques that the processing system may use to generate synthetic data. In other words, the alternatively sampled data values may be considered to be synthetic data values insofar as they are not originally sampled/selected. In another example, 235 may be omitted. For instance, in one example, all detected missing data values may be filled-in/replaced with synthetic data generated at 245. Thus, these and other modifications are all contemplated within the scope of the present disclosure.

FIG. 3 illustrates a flowchart of an example method 300 for performing at least one network management task in a communication network in response to an output of a first machine learning model (e.g., a current deployed machine learning model) in accordance with an input vector comprising one or more replacement data values for one or more missing data values of a first network performance data feature type, in accordance with the present disclosure. In one example, steps, functions and/or operations of the method 300 may be performed by a device as illustrated in FIG. 1, e.g., NWDAF 192, SMO 190, and/or RIC 199, etc., or any one or more components thereof, such as a processing system, or collectively via a plurality devices in FIG. 1, such as NWDAF 192, SMO 190, and/or RIC 199, etc. in conjunction with another one or more of NWDAF 192, SMO 190, and/or RIC 199, etc. in conjunction with cell sites 121 and 122, BBU pool 126, and so forth. In one example, the method 300 may be performed by a similar device or system that is not necessarily part of a cellular networking infrastructure, such as a SDN controller, SON orchestrator, or the like. In one example, the steps, functions, or operations of method 300 may be performed by a computing device or system 400, and/or a processing system 402 as described in connection with FIG. 4 below. For instance, the computing device 400 may represent at least a portion of a NWDAF, SMO, RIC, etc. in accordance with the present disclosure. For illustrative purposes, the method 300 is described in greater detail below in connection with an example performed by a processing system, such as processing system 402. The method 300 begins in step 305 and may proceed to optional step 310 or to step 315.

At optional step 310, the processing system may obtain a data stream for a first network performance data feature type (or a parameter type) for a plurality of time slots. In one example, the first network performance data feature type may be one of a plurality of network performance data feature types. In addition, the plurality of network performance data feature types may include one or more communication network performance indicator types and/or one or more network configuration setting types.

At step 315, the processing system detects one or more missing data values of a first network performance data feature type of a communication network for one or more time slots of a plurality of time slots. For instance, the detecting of the one or more missing data values may be from within the data stream. In other words, the data stream may comprise the one or more missing data values for the one or more time slots (along with various data values (i.e., that are not missing) for the rest of the time slots of the plurality of time slots). Alternatively, or in addition, one or more features may be missing data values at one time slot as well. For instance, one or several configuration parameter values may not be reported by a base station due to any fault in a data reporting pipeline. It should be noted that for some network performance data feature types, data values may be collected/reported on occurrence of events, where there is no reporting when an event does not occur. However, for these data types, time slots without an event may not be deemed to be “missing” data values, but may have a default data value of zero, “no event,” or the like.

At optional step 320, the processing system may determine that one or more data values from nearby time slots are available. For instance, “nearby” may be within a threshold number of time slots or may be time slots that could have been alternatively selected for sampling from within a sampling interval. In one example, a collection frequency for the first network performance data feature type may be greater than a sampling frequency of the first network performance data feature type (e.g., resulting in an excess amount data values for a particular application). In particular, these nearby time slots may have data values that were previously un-sampled for purposes of inclusion in the data stream (and/or for use as an input data vector to a machine learning model), and which may be used in lieu of one or more missing data values. For instance, since the samples are close enough in time and/or could similarly have been sampled according to a random sampling, periodic sampling, or the like, these data values may be accurate stand-ins. In one example, “nearby” may be a number of time slots defined by network personnel and/or determined based upon past machine learning model performance using data values from “nearby” time slots (e.g., where the distance in terms of a number of time slots is recorded and the performance/accuracy tracked based on different distances).

At optional step 325, the processing system may determine that the first machine learning model is incapable of proceeding with the one or more missing data values. For instance, in one example, the determining of optional step 325 may be based upon the type of machine learning being known to be capable/incapable of operating with missing data values.

At step 330, the processing system generates one or more replacement data values to fill in for the one or more of the missing data values of the first network performance data feature type for the one or more time slots. In one example, the one or more replacement data values may comprise one or more data values from nearby time slots that are close in time to the one or more time slots having the one or more missing data values. For instance, in such an example, the generating may comprise copying or allocating the one or more data values from nearby time slots (e.g., that may be identified at optional step 325) to the one or more time slots having the one or more missing data values. Alternatively, or in addition, the generating may be via at least one of: a statistical process or an application of a generative machine learning model, such as a GAN, a VAE, etc. In one example, the generating of the one or more synthetic data values at step 330 may be in response to the determining that the performance of the first machine learning model is insufficient at optional step 325.

At step 335, the processing system applies an input vector comprising at least the one or more replacement data values to the first machine learning model to obtain an output of the first machine learning model in accordance with the input vector. For instance, the first machine learning model may be implemented by the processing system and may be trained/configured to perform a network management inference task. In one example, the training may configure the first machine learning model to generate one or more outputs in response to an input data vector comprising one or more data values for one or more data feature types and over one or more time periods. The first machine learning model may comprise a DNN, a CNN, a RNN, a LSTM model, a transformer network, an encoder-decoder neural network, an encoder neural network, a decoder neural network, a VAE, a GAN, a decision tree algorithm/model, such as a GBDT, a GPT model or other large language model (LLM), and so forth.

At step 340, the processing system performs at least one network management task in the communication network in response to the output. For instance, the at least one network management task may include configuring at least a second aspect of the communication network in response to the output and/or transmitting an alert (e.g., a report, a notification message, etc.) in response to the output, e.g., to one or more endpoint devices of network personnel and/or to one or more other automated systems of the communication network (such as a NWDAF transmitting an alert/report to a SMO, a RIC, etc.). For example, the processing system may provide individual or aggregate reports to one or more other NFs, e.g., on a subscription basis and/or on-demand. For instance, a SMO and/or a RIC may obtain an alert from the processing system, and may use such information to automatically configure/reconfigure one or more aspects of an access network, a cell site, etc. Likewise, in one example the processing system may provide an alert (e.g., an individual alert and/or a report comprising multiple alerts) to one or more endpoint devices of network personnel, e.g., for manual investigation, troubleshooting, and/or remediation, for network planning, and so forth.

At optional step 345, the processing system may detect a second set of one or more missing data values of the first network performance data feature type for a second threshold number of consecutive time slots. For instance, the second threshold number of consecutive time slots may be greater than the first threshold number of consecutive time slots. In one example, the second threshold number of consecutive time slots may be a number of time slots of missing data values for which a second model that is configured for the same task as the first machine learning model may have a greater accuracy that the first machine learning model (e.g., the current deployed machine learning model). For instance, the second model may be a second MLM, an AI model and/or a rule-based or formulaic model, or the like. At optional step 350, the processing system may replace the first machine learning model with the second model for the same forecasting or classification task, in response to the detecting of the second set of one or more missing data values of the first network performance data feature type for the second threshold number of consecutive time slots. For example, a determination of whether to switch to the second model may be based upon both the second accuracy metric and the third accuracy metric (e.g., switch when the second model will perform better). In other words, the second model may be determined to have better performance for the same task when more than N consecutive time slots of data are missing for the first network performance data feature type.

At optional step 355, the processing system may apply a second input vector to the second model to obtain a second output of the second model in response to the second input vector. It should be noted that in one example, the second input vector may include the data values that is/are available for the first network performance data feature type. However, in another example, the second input vector may utilize other features and/or may omit use of the first network performance data feature type. For instance, the second model may output a similar type of inference (e.g., prediction/forecast, classification, or the like), but may use a different set of features as inputs. Thus, in one example, the missing data values may be of no consequence to the performance of the second model.

At optional step 360, the processing system may perform at least a second network management task in the communication network in response to the second output. For instance, the processing system may configure at least a second aspect of the communication network in response to the second output and/or may transmit an alert, e.g., to one or more endpoint devices of network personnel and/or to one or more other automated systems of the communication network (such as a NWDAF transmitting an alert/report to a SMO, a RIC, etc.).

Following step 340 or any of optional steps 345-360, the method 300 may proceed to step 395 where the method 300 ends.

It should be noted that the method 300 may be expanded to include additional steps or may be modified to include additional operations with respect to the steps outlined above. In one example, various steps of the method 300 may be repeated for subsequent time periods for the same network management inference task using the first machine learning model and/or the second model, may be repeated for a different portion of the communication network (e.g., in a cellular network, for the same or different cell site, sector, or the like, for a different cell site or sector, etc.), and so forth. In one example, step 315 may alternatively or additional comprise detecting missing 3^{rd} party data values. For instance, examples of the present disclosure may not be limited to network performance indicators, or configuration settings, but may also account for missing 3rd party data, e.g., weather data, etc. that may be used as part of an input vector for a ML-based network management inference task. In one example, optional step 325 may be performed preceding optional step 320. In one example, the method 300 may be expanded to further include training the first machine learning model, the second model, etc. In one example, the method 300 may be expanded or modified to include steps, functions, and/or operations, or other features described above in connection with the example(s) of FIGS. 1 and 2, or as described elsewhere herein. Thus, these and other modifications are all contemplated within the scope of the present disclosure.

In addition, although not specifically specified, one or more steps, functions, or operations of the example method 200 and method 300 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 3 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 4 depicts a high-level block diagram of a computing device or processing system specifically programmed to perform the functions described herein. As depicted in FIG. 4, the processing system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for performing at least one network management task in a communication network in response to an output of a first machine learning model in accordance with an input vector comprising one or more replacement data values for one or more missing data values of a first network performance data feature type, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 406 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 402 can also be configured or programmed to cause other devices to perform one or more operations as discussed above. In other words, the hardware processor 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 405 for performing at least one network management task in a communication network in response to an output of a first machine learning model in accordance with an input vector comprising one or more replacement data values for one or more missing data values of a first network performance data feature type (e.g., a software program comprising computer-executable instructions) can be loaded into memory 404 and executed by hardware processor element 402 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for performing at least one network management task in a communication network in response to an output of a first machine learning model in accordance with an input vector comprising one or more replacement data values for one or more missing data values of a first network performance data feature type (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
detecting, by a processing system including at least one processor, one or more missing data values of a first network performance data feature type of a communication network for one or more time slots of a plurality of time slots;
generating, by the processing system, one or more replacement data values for the one or more of the missing data values of the first network performance data feature type for the one or more time slots;
applying, by the processing system, an input vector comprising at least the one or more replacement data values to a first machine learning model to obtain an output of the first machine learning model in accordance with the input vector; and
performing, by the processing system, at least one network management task in the communication network in response to the output.

2. The method of claim 1, wherein the first network performance data feature type comprises one of a plurality of network performance data feature types, and wherein the plurality of network performance data feature types comprises one or more communication network performance indicator types.

3. The method of claim 1, wherein the first network performance data feature type comprises one of a plurality of network performance data feature types, and wherein the plurality of network performance data feature types comprises one or more network configuration setting types.

4. The method of claim 1, further comprising:
determining that a performance of the first machine learning model is insufficient with the one or more missing data values, wherein the generating of the one or more replacement data values is in response to the determining that the performance of the first machine learning model is insufficient with the one or more missing data values.

5. The method of claim 4, wherein the determining that the performance of the first machine learning model is insufficient with the one or more missing data values is based upon a first performance metric of the first machine learning model for one or more past input data vectors.

6. The method of claim 4, wherein the determining that the performance of the first machine learning model is insufficient with the one or more missing data values comprises determining that the performance of the first machine learning model is insufficient when data values of the first network performance data feature type are missing in a first threshold number of consecutive time slots.

7. The method of claim 6, further comprising:
detecting a second set of one or more missing data values of the first network performance data feature type for a second threshold number of consecutive time slots, wherein the second threshold number of consecutive time slots is greater than the first threshold number of consecutive time slots.

8. The method of claim 7, wherein the second threshold number of consecutive time slots comprises a number of times slots of missing data values for which a second model that is configured for the same task as the first machine learning model may have a superior performance to the first machine learning model.

9. The method of claim 8, further comprising:
replacing the first machine learning model with the second model for the same task, in response to the detecting of the second set of one or more missing data values of the first network performance data feature type for the second threshold number of consecutive time slots.

10. The method of claim 9, further comprising:
applying a second input vector to the second model to obtain a second output of the second model in response to the second input vector; and
performing at least a second network management task in the communication network in response to the second output.

11. The method of claim 1, wherein the one or more replacement data values comprise one or more synthetic data values.

12. The method of claim 11, wherein the generating of the one or more replacement data values is via at least one of:
a statistical process; or
an application of a generative machine learning model.

13. The method of claim 1, wherein the one or more replacement data values comprise one or more data values from nearby time slots that are close in time to the one or more time slots having the one or more missing data values.

14. The method of claim 13, wherein a collection frequency for the first network performance data feature type is greater than a sampling frequency of the first network performance data feature type.

15. The method of claim 13, further comprising:
determining that one or more data values from the nearby time slots are available.

16. The method of claim 1, further comprising:
obtaining a data stream for the first network performance data feature type for the plurality of time slots including the one or more time slots.

17. The method of claim 1, wherein the at least one network management task comprises transmitting an alert in response to the output.

18. The method of claim 1, wherein the at least one network management task comprises configuring at least one aspect of the communication network in response to the output.

19. A non-transitory computer-readable medium storing instructions which, when executed by a processing system including at least one processor, cause the processing system to perform operations, the operations comprising:
detecting one or more missing data values of a first network performance data feature type of a communication network for one or more time slots of a plurality of time slots;
generating one or more replacement data values for the one or more of the missing data values of the first network performance data feature type for the one or more time slots;
applying an input vector comprising at least the one or more replacement data values to a first machine learning model to obtain an output of the first machine learning model in accordance with the input vector; and
performing at least one network management task in the communication network in response to the output.

20. An apparatus comprising:
a processing system including at least one processor; and
a computer-readable medium storing instructions which, when executed by the processing system, cause the processing system to perform operations, the operations comprising:
detecting one or more missing data values of a first network performance data feature type of a communication network for one or more time slots of a plurality of time slots;
generating one or more replacement data values for the one or more of the missing data values of the first network performance data feature type for the one or more time slots;
applying an input vector comprising at least the one or more replacement data values to a first machine learning model to obtain an output of the first machine learning model in accordance with the input vector; and
performing at least one network management task in the communication network in response to the output.
